(19) United States
(12) Patent Application Publication
(10) Pub. No.: US 2021/0182615 A1
(43) Pub. Date: Jun. 17, 2021

(54) ALEXNET-BASED INSULATOR SELF-EXPLOSION RECOGNITION METHOD

(71) Applicant: Yongchuan Power Supply Branch, State Grid Chongqing Electric Power Company, Chongqing (CN)

(72) Inventors: Yingguo Li, Chongqing (CN); Junji Chen, Chongqing (CN); Jie Zhou, Chongqing (CN); Shucai Yin, Chongqing (CN); Hong Yang, Chongqing (CN); Xinru Mao, Chongqing (CN); Tao He, Chongqing (CN); Jianxin Chen, Chongqing (CN); Liang Huang, Chongqing (CN); Qinzhi Jiang, Chongqing (CN); Weijian Xia, Chongqing (CN); Hongchun Yang, Chongqing (CN)

(73) Assignee: Yongchuan Power Supply Branch, State Grid Chongqing Electric Power Company, Chongqing (CN)

(21) Appl. No.: 17/122,884

(22) Filed: Dec. 15, 2020

(30) Foreign Application Priority Data
Dec. 16, 2019 (CN) 201911290785.X

(51) Int. Cl. G06K 9/62; G06N 20/10; B64C 39/02

(52) U.S. Cl. CPC G06K 9/6257; G06K 9/6267; B64C 2201/127; B64C 39/024; G06N 20/10

(57) ABSTRACT

The present disclosure provides an AlexNet-based insulator self-explosion detection method using an unmanned aerial vehicle (UAV), including: acquiring image and video information collected by a robot patrolling and spanning an obstacle on a wire and the UAV; performing rapid data augmentation on the acquired image and video information based on an existing training data set, to divide the data set into two parts, which are respectively a training set and a test set; extracting an image feature and a class tag from the training data set and the test data set for classification; and training, by using the obtained training set and test set, a support vector machine (SVM) detection model that can recognize insulator self-explosion and that is obtained based on AlexNet. The detection model can recognize the acquired image and video information, to determine whether there is a self-exploded insulator based on the image and video information.

### TECHNICAL FIELD

The present disclosure belongs to the technical field of electric power maintenance, in particular, to provide an AlexNet-based insulator self-explosion recognition method.

### BACKGROUND

An insulator string performs electrical isolation and mechanical support in a high voltage transmission line, and is an important component of the high voltage transmission line. A damaged insulator can lead to a power failure on a power line, causing huge inconvenience and losses to people's life and enterprise production. Therefore, real-time defect monitoring for an insulator is an important research direction with practical significance in a safe operation of a power system.

A manual line patrol method is most commonly used to detect an insulator defect. That is, the insulator defect is determined through on-site manual observation. However, in the manual line patrol method, relatively long time is consumed, and timeliness cannot be guaranteed. Currently, there are relatively high labor costs, and this method is increasingly unable to meet an actual requirement of the power system. Another method is an image method. An insulator defect is determined by using an insulator image or video taken by a device. However, such inspection usually has very high manpower and energy requirements, and consumes both energy and time. It is difficult to maintain high precision during inspection. Therefore, an intelligent algorithm-based insulator defect recognition technology has attracted more attention from the industrial and academic circles, and is a mainstream direction of insulator defect recognition in the future.

### SUMMARY

The present disclosure aims to provide an AlexNet-based insulator self-explosion recognition method, to resolve a problem that in an existing insulator recognition method, both efforts and energy are consumed, and recognition precision cannot meet a real life requirement.

The present disclosure provides an AlexNet-based insulator self-explosion recognition method, including the following steps:

step 1: acquiring image and video information collected by a robot patrolling and spanning an obstacle on a wire and an unmanned aerial vehicle;

step 2: performing rapid data augmentation on the acquired image and video information based on an existing training data set, to divide the data set into two parts, which are respectively a training set and a test set;

step 3: extracting an image feature and a class tag from the training data set and the test data set for classification; and

step 4: training, by using the obtained training set and test set, an SVM detection model that can recognize insulator self-explosion and that is obtained based on AlexNet, where the insulator self-explosion recognition model performs classification based on whether an insulator is self-exploded.

There are three manners of performing data augmentation in step 2:

(a) Random cropping. A 256×256 image is randomly cropped to 224×224, and is then horizontally flipped, which is equivalent to increasing a quantity of samples by ((256−224)\hat{ }²)×2=2048.

(b) Horizontal flip. During a test, the image is respectively cropped for five times at an upper left location, at an upper right location, at a lower left location, at a lower right location, and at a middle location, and is then flipped. There is a total of 10 times of cropping. Then, results obtained after 10 predictions are averaged.

(c) Change a contrast. PCA (principal component analysis) is performed on RGB space, and a Gaussian perturbation with a mean value of 0 and a standard deviation of 0.1 is performed on a principal component. That is, a color and light are changed. In this way, an error rate is reduced by another 1%.

A specific step of dividing the data set in step 2 is as follows:

The data set is divided by using a proportional division tool, 70% of the data set is used as a training data set, and 30% of the data set is used as a test data set. The training set is used to construct the model, and the test set is used to evaluate performance of a final model.

A specific step of extracting the image feature in step 3 is as follows:

(a) Perform an enhancement operation on data in the data set by using an image enhancement database, to increase a data amount.

(b) Extract the image feature by using an activation function of a neural network toolbox.

A specific step of extracting an image class label in step 3 is as follows:

The class tag is extracted from the training data set and the test data set, and class tags include “good” and “bad”.

A specific step of training the model in step 4 is as follows:

The AlexNet used in this method has a total of 25 layers, including five convolutional layers and three fully connected layers. The layers are sequentially as follows:

(a) First Convolutional Layer

In the first convolutional layer, input original data is an image of 227*227*3. The image is convolved by a convolution kernel of 11*11*3. The convolution kernel generates a new pixel each time the convolution kernel convolves the original image. The convolution kernel moves in an X-axis direction and a Y-axis direction of the original image, and a step length of movement is 4 pixels. Therefore, in a movement process, the convolution kernel generates (227−11)/4+1=55 pixels, and 55*55 pixels of rows and columns form a pixel layer after the original image is convolved. There are a total of 96 convolution kernels, and 55*55*96 pixel layers are generated after convolution. The 96 convolution kernels are divided into two groups, and each group includes 48 convolution kernels. Correspondingly, two groups of pixel layer data of 55*55*48 are generated after convolution. These pixel layers are processed by ReLU1 to generate active pixel layers, and a size is still two groups of pixel layer data of 55*55*48.

These pixel layers are processed through a pooling operation (pooling operation). A size of the pooling operation is 3*3, and a step length of the operation is 2. Therefore, a size of a pooled image is (55−3)/2+1=27. After pooling, a pixel size is 27*27*96. Then, normalization processing is performed, and a size of a normalization operation is 5*5. A size of a pixel layer formed after the operation at the first convolutional layer is completed is 27*27*96. The pixel layer is separately formed through operations performed by 96 corresponding convolution kernels. The 96 pixel layers are divided into two groups, each group includes 48 pixel layers, and an operation is performed on each group in a separate GPU.

During backpropagation, each convolution kernel corresponds to one deviation value. That is, the 96 convolution kernels at the first layer correspond to 96 deviation values input by an upper layer.

(b) Second Convolutional Layer

Input data of the second layer is the pixel layer of 27*27*96 output by the first layer. To facilitate subsequent processing, left and right sides and top and bottom sides of each pixel layer each needs to be filled with two pixels. Pixel data of 27*27*96 is divided into two groups of pixel data of 27*27*48, and the two groups of data are respectively calculated in two different GPUs. Each group of pixel data is convolved by a convolution kernel of 5*5*48. The convolution kernel generates a new pixel each time the convolution kernel convolves each group of data. The convolution kernel moves in the X-axis direction and the Y-axis direction of the original image, and a step length of movement is one pixel. Therefore, in a movement process, the convolution kernel generates (27−5+2*2)/1+1=27 pixels, and 27*27 pixels of rows and columns form a pixel layer after the original image is convolved. There are 256 convolution kernels of 5*5*48. The 256 convolution kernels are divided into two groups, and each group convolves a pixel of 27*27*48 in one GPU. Two groups of pixel layers of 27*27*128 are generated after convolution. These pixel layers are processed by ReLU2 to generate active pixel layers, and sizes are still two groups of pixel layers of 27*27*128.

These pixel layers are processed through a pooling operation (pooling operation). A size of the pooling operation is 3*3, and a step length of the operation is 2. Therefore, a size of a pooled image is (57−3)/2+1=13. That is, after pooling, a pixel size is two groups of pixel layers of 13*13*128. Then, normalization processing is performed, and a size of a normalization operation is 5*5. A size of a pixel layer formed after the operation at the second convolutional layer is completed is two groups of pixel layers of 13*13*128. The pixel layers are separately formed through operations performed by two groups of 128 corresponding convolution kernels. An operation is performed on each group in one GPU. That is, there are a total of 256 convolution kernels, and a total of 2 GPUs perform operations.

During backpropagation, each convolution kernel corresponds to one deviation value. That is, the 96 convolution kernels at the first layer correspond to 256 deviation values input by an upper layer.

(c) Third Convolutional Layer

Input data of the third layer is two groups of pixel layers of 13*13*128 output by the second layer. To facilitate subsequent processing, left and right sides and top and bottom sides of each pixel layer each needs to be filled with one pixel. Two groups of pixel layer data are sent to two different GPUs for computation. There are 192 convolution kernels in each GPU, and a size of each convolution kernel is 3*3*256. Therefore, convolution kernels in each GPU can convolve all data of two groups of pixel layers of 13*13*128. The convolution kernel generates a new pixel each time the convolution kernel convolves each group of data. The convolution kernel moves in the X-axis direction and the Y-axis direction of the pixel layer data, and a step length of movement is one pixel. Therefore, a size of the convolution kernel after an operation is (13-3+1*2)/1+1=13, and there are a total of 13*13*192 convolution kernels in each GPU. There are a total of 13*13*384 pixel layers after convolution in the two GPUs. These pixel layers are processed by ReLU3 to generate active pixel layers, and a size is still two groups of pixel layers of 13*13*192. There are a total of 13*13*384 pixel layers.

(d) Fourth Convolutional Layer

Input data of the fourth layer is two groups of pixel layers of 13*13*192 output by the third layer. To facilitate subsequent processing, left and right sides and top and bottom sides of each pixel layer each needs to be filled with one pixel. Two groups of pixel layer data are sent to two different GPUs for computation. There are 192 convolution kernels in each GPU, and a size of each convolution kernel is 3*3*192. Therefore, convolution kernels in each GPU can convolve data of one group of pixel layers of 13*13*192. The convolution kernel generates a new pixel each time the convolution kernel convolves each group of data. The convolution kernel moves in the X-axis direction and the Y-axis direction of the pixel layer data, and a step length of movement is one pixel. Therefore, a size of the convolution kernel after an operation is (13−3+1*2)/1+1=13, and there are a total of 13*13*192 convolution kernels in each GPU. There are a total of 13*13*384 pixel layers after convolution in the two GPUs. These pixel layers are processed by ReLU4 to generate active pixel layers, and a size is still two groups of pixel layers of 13*13*192. There are a total of 13*13*384 pixel layers.

(e) Fifth Convolutional Layer

Input data of the fifth layer is two groups of pixel layers of 13*13*192 output by the fourth layer. To facilitate subsequent processing, left and right sides and top and bottom sides of each pixel layer each needs to be filled with one pixel. Two groups of pixel layer data are sent to two different GPUs for computation. There are 128 convolution kernels in each GPU, and a size of each convolution kernel is 3*3*192. Therefore, convolution kernels in each GPU can convolve data of one group of pixel layers of 13*13*192. The convolution kernel generates a new pixel each time the convolution kernel convolves each group of data. The convolution kernel moves in the X-axis direction and the Y-axis direction of the pixel layer data, and a step length of movement is one pixel. Therefore, a size of the convolution kernel after an operation is (13−3+1*2)/1+1=13, and there are a total of 13*13*128 convolution kernels in each GPU. There are a total of 13*13*256 pixel layers after convolution in the two GPUs. These pixel layers are processed by ReLU5 to generate active pixel layers, and a size is still two groups of pixel layers of 13*13*128. There are a total of 13*13*256 pixel layers.

Pooling operation processing is performed on two groups of pixel layers of 13*13*128 respectively in two different GPUs. A size of a pooling operation is 3*3, and a step length of the operation is 2. Therefore, a size of a pooled image is (13-3)/2+1=6. That is, after pooling, a pixel size is two groups of pixel layer data of 6*6*128, and there is pixel layer data of 6*6*256 in total.

(f) First Connected Layer

A size of input data of the sixth layer is 6*6*256, and a filter with a size of 6*6*256 is used to convolve the input data of the sixth layer. Each filter with a size of 6*6*256 convolves the input data of the sixth layer to generate an operation result, and outputs an operation result through a neuron. A total of 4096 filters with the size of 6*6*256 convolve the input data, and output operation results through 4096 neurons. The 4096 operation results are used to generate 4096 values through an ReLU activation function. After a drop operation, 4096 output result values of respective layers are output.

In an operation process at the sixth layer, the size (6*6*256) of the used filter is the same as a size (6*6*256) of a to-be-processed feature map. That is, each coefficient of the filter is multiplied by only one pixel value in the feature map. However, in other convolutional layers, a coefficient of each filter is multiplied by pixel values in a plurality of feature maps. Therefore, the sixth layer is referred to as a fully connected layer.

(g) Second Fully Connected Layer

The 4096 pieces of data output from the sixth layer are fully connected to 4096 neurons at the seventh layer, then are processed by ReLU7 to generate 4096 pieces of data, and then are processed by using dropout7 to output 4096 pieces of data.

(h) Third Fully Connected Layer

The 4096 pieces of data output from the seventh layer are fully connected to 1000 neurons at the eighth layer, and then are trained to output a trained value.

The present disclosure has the following beneficial effects:

The present disclosure provides an AlexNet-based insulator self-explosion recognition method. After preprocessing such as image preprocessing and data set division, an AlexNet-based SVM performs classification recognition on images. In this way, a speed and accuracy of recognizing a fault of an insulator of a power cable are improved, costs are reduced, and application of a deep learning method to image recognition in the power system field is promoted.

### BRIEF DESCRIPTION OF DRAWINGS

FIG. 1 is a flowchart of an AlexNet-based insulator self-explosion recognition method according to the present disclosure;

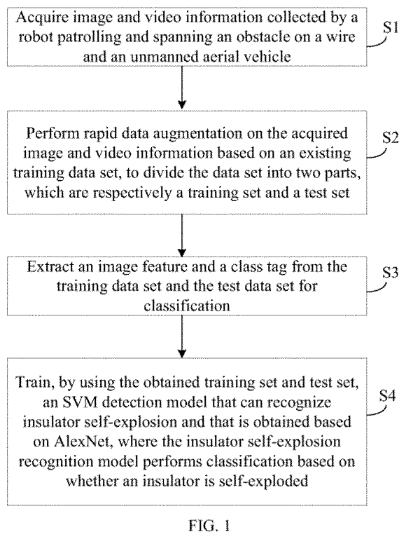

FIG. 2 is a diagram of application of AlexNet according to the present disclosure;

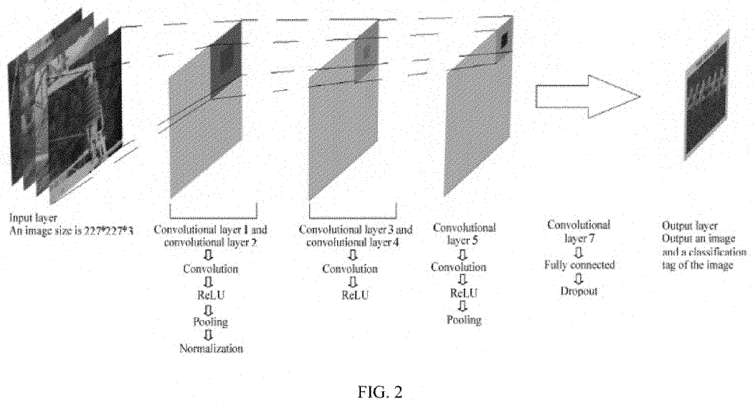

FIG. 3 is a diagram of some processed insulators according to an embodiment of the present disclosure;

FIG. 4 is a schematic diagram of a network training process according to an embodiment of the present disclosure; and

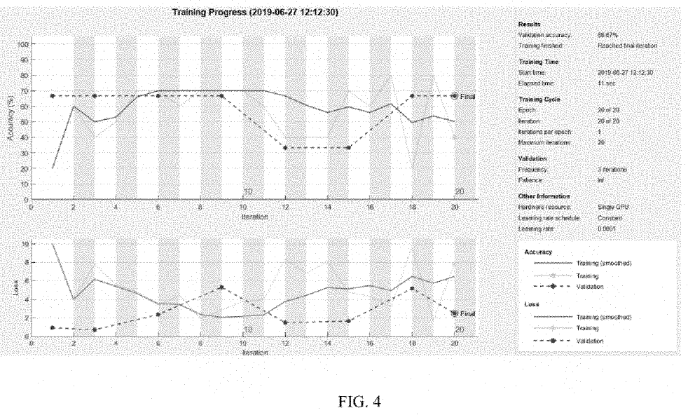

FIG. 5 is a diagram of an insulator self-explosion recognition classification effect according to an embodiment of the present disclosure.

### DETAILED DESCRIPTION

The following describes an AlexNet-based insulator self-explosion recognition method in embodiments of the present disclosure in detail with reference to the accompanying drawings.

### Embodiment 1

1. Data Set Processing

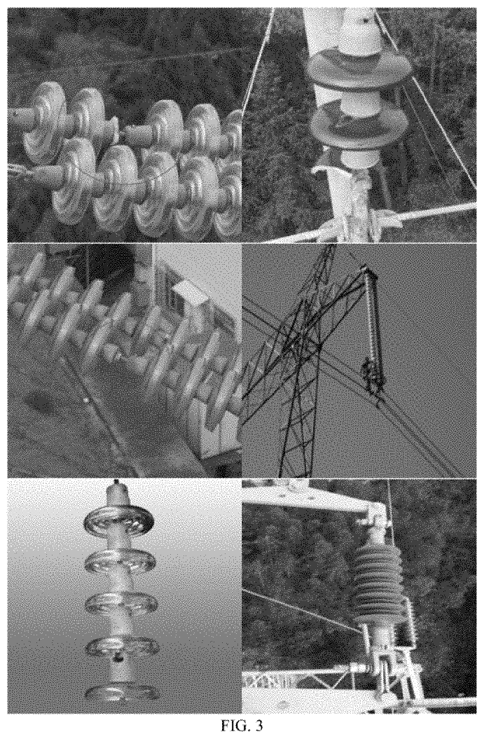

Referring to FIG. 3, a total of 28 images are obtained, including 10 images of self-exploded insulators, and 18 images of good insulators. The images are processed to images of 227*227*3. Herein, 227 is a width size and a height size, and 3 is a quantity of channels.

2. Data Set Division

A data set is divided according to tags by using a division tool, 70% of the data set is used as training data, and 30% of the data set is used as test data.

3. Load a Pre-Trained Network

Input data of AlexNet is an image of 227*227*3. There are 5 convolutional layers and 3 fully connected layers in total. A ReLU function is used as an activation function, and max pooling is used as a pooling policy. Two dropout layers are interspersed between the three fully connected layers, and there is a 50% probability that some neurons are discarded, to prevent overfitting in a deep neural network. There are two standardization layers between the convolutional layers, to improve accuracy.

4. Trained Network

A validation set is 20% of the entire data set, with 20 iterations, a learning rate of 0.0001, and a final validation accuracy rate of 66.67%.

5. Extract an Image Feature

An image enhancement database is first used to perform an enhancement operation on data in the data set, and then an activation function of a neural network toolbox is used to extract the image feature.

6. Extract a Class Tag

The class tag is extracted from the training data set and a test data set.

7. Fit an Image Classifier

A feature extracted from a training image is used as a predictive variable, and statistics collection provided by MATLAB and fitcecoc in a machine learning toolbox are used to fit a multi-class support vector machines (SVM).

8. Classify Test Images

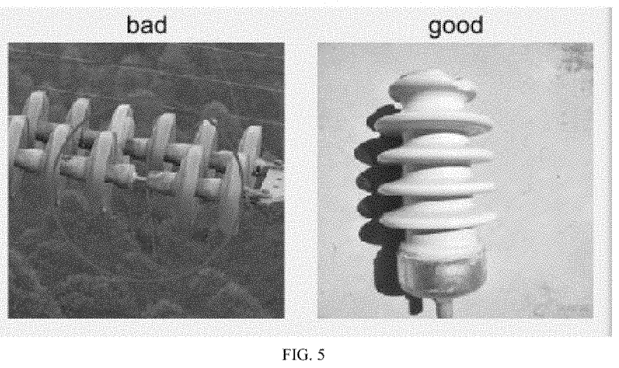

Referring to FIG. 5, a trained SVM model and features extracted from the test images are used to classify the test images, and a classification effect is shown in the figure.

9. Calculate Accuracy of Network Prediction

Classification accuracy of the test set is calculated. The accuracy is a proportion of correct tags predicted by a network. After ten iterations, an accuracy rate reaches 87.5%.

Content not mentioned in the present disclosure shall be a widely-known technology.

One aspect of the present disclosure is directed to an AlexNet-based insulator self-explosion recognition method. The method comprises acquiring image and video information collected by a robot patrolling and spanning an obstacle on a wire and an unmanned aerial vehicle (UAV); performing rapid data augmentation on the acquired image and video information based on an existing training data set, to divide the data set into two parts, which are respectively a training set and a test set extracting an image feature and a class tag from the training data set and the test data set for classification; and training, by using the obtained training set and test set, a support vector machine (SVM) detection model that can recognize insulator self-explosion and that is obtained based on AlexNet, wherein the insulator self-explosion recognition model performs classification based on whether an insulator is self-exploded.

The above embodiments are intended to illustrate only the technical conception and characteristics of the present disclosure, and are intended to enable a person familiar with the technology to understand content of the present disclosure and apply the content accordingly, and shall not limit the scope of protection of the present disclosure thereby. Any equivalent change or modification in accordance with the spiritual essence of the present disclosure shall fall within the scope of protection of the present disclosure.

What is claimed is:

1. An AlexNet-based insulator self-explosion recognition method, comprising the following steps:
step 1: acquiring image and video information collected by a robot patrolling and spanning an obstacle on a wire and an unmanned aerial vehicle (UAV);
step 2: performing rapid data augmentation on the acquired image and video information based on an existing training data set, to divide the data set into two parts, which are respectively a training set and a test set;
step 3: extracting an image feature and a class tag from the training data set and the test data set for classification; and
step 4: training, by using the obtained training set and test set, a support vector machine (SVM) detection model that can recognize insulator self-explosion and that is obtained based on AlexNet, wherein the insulator self-explosion recognition model performs classification based on whether an insulator is self-exploded.
